(19) United States
(12) Patent Application Publication
(10) Pub. No.: US 2025/0028760 A1
(43) Pub. Date: Jan. 23, 2025

(54) System and Method for Record Values Analysis

(71) Applicant: Cogility Software Corporation, Irvine, CA (US)

(72) Inventor: Michael Allen Latta, Greeley, CO (US)

(21) Appl. No.: 18/356,107

(22) Filed: Jul. 20, 2023

(51) Int. Cl. G06F 16/901

(52) U.S. Cl. CPC G06F 16/901

(57) ABSTRACT

Methods and systems for analyzing data values are disclosed. From one or more sources, source data is received as records, with each record including data values. For each record, the record is broken into value records, and from the record metadata about the record is extracted, where each value record includes one data value. The value records are indexed based on the respective data values of the value records, to produce value indices. One or more value pattern instances of a value pattern is/are used to establish relationships between the value records and produce value pattern outcomes based on at least one of: the value indices or the respective data values of the value records.

### FIELD OF THE INVENTION

Embodiments of the present disclosure relate generally to event processing. More particularly, embodiments of the disclosure relate to system and method to analyze values in a record.

### BACKGROUND

Data analytics, which include analyzing of security data, cyber data analysis, website click data, etc., have been increasingly important to governments, businesses, organizations, and individuals as they can help understand patterns and trends. It is therefore important to have intelligent data analytics that can timely and effectively process information to identify those patterns and trends that can be useful in various applications, for example, detecting and preventing potential security threats and responding to threats that are in the development stage, making business decisions, helping analyze customer trends and satisfaction (which can lead to new and better products and services), etc.

With the availability of massive amounts of data aggregated from a number of sources, such as transaction systems, social networks, web activity, history logs, etc., it has become a necessity to use data technologies for mining and correlating useful information. However, in analyzing data, computing industry generally analyzes the data as records since data is generally in record form or can be restructured into record form. A record is a group or collection of fields holding values about one or more entities. This generally requires that all the fields about an entity be moved from place to place in order to perform the desired processing. Thus, this often requires that a specific field holding a value must be both known and specified to perform the desired processing.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a processing system according to an embodiment.

FIG. 2 is a block diagram illustrating a server system according to an embodiment.

FIG. 3A is a block diagram illustrating a value analysis data flow according to an embodiment.

FIG. 3B is a block diagram illustrating a value analysis data flow according to another embodiment.

FIG. 4A is a block diagram illustrating a value pattern resolution data flow according to an embodiment.

FIG. 4B is a block diagram illustrating a value pattern resolution data flow according to another embodiment.

FIG. 5 is a flow diagram illustrating a process of analyzing data values according to an embodiment.

FIG. 6 is a flow diagram illustrating a process for value pattern resolution according to an embodiment.

### DETAILED DESCRIPTION

Various embodiments and aspects of the disclosure will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present disclosure. However, in certain instances, well-known or conventional details are not described in order to provide a concise discussion of embodiments of the present disclosure.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

Embodiments of the disclosure are related to intelligent data analytics (e.g., analyzing of security data, cyber data analysis, website click data, etc.) that can timely and effectively process information to identify patterns and trends that can be useful in various applications, for example, detecting and preventing potential security threats and responding to threats that are in the development stage, making business decisions, helping analyze customer trends and satisfaction (which can lead to new and better products and services), etc. Embodiments of the disclosure provide computing/analysis tasks on values rather than records. The association between values and records, where the values came from, may be retained, but the records, as a whole, are not moved from one computing task to another. In this way, some unique insights are gained by being able to ignore the fields from which the value came.

Moreover, when the data format is unknown (e.g., data acquired from adversaries, or data under control of another organization), embodiments of the disclosure provide value in resiliency in the face of schema changes or unknown schema structure and field intent.

According to one aspect, a computer-implemented method of analyzing data values is provided. From one or more sources, source data may be received as records, with each record including data values. For each record, the record may be broken into value records, and from the record metadata about the record may be extracted, where each value record may include one data value. The value records may be indexed based on the respective data values of the value records, to produce value indices. One or more value pattern instances of a value pattern may be used to establish relationships between the value records and produce value pattern outcomes based on at least one of: the value indices or the respective data values of the value records.

In an embodiment, metadata edits may be backfilled to the value records, where the metadata edits are edits made to the extracted metadata about the records.

In using the value pattern instance(s) of the value pattern to establish relationships between the value records and produce the value pattern outcomes, for each value pattern instance, a first relationship between the value records may be established based on the value pattern instance, the value indices, and the respective data values of the value records, to produce a subset of the value records with the first relationship and a subset of the value indices corresponding to the subset of the value records. Furthermore, a second relationship between the subset of the value records may be established based on the value pattern instance, the subset of the value indices, and the respective data values of the subset of the value records.

Each value pattern instance may include slots holding a set of value records. In using the value pattern instance(s) of the value pattern to establish relationships between the value records and produce the value pattern outcomes, for each value pattern instance, one or more solutions may be determined based on the established first and second relationships, where the solution(s) may include a first value record held in a first slot and a second value record held in a second slot. Furthermore, a value pattern outcome may be constructed and produced based on the solution(s).

In using the value pattern instance(s) of the value pattern to establish relationships between the value records and produce the value pattern outcomes, for each value pattern instance, the solution(s) may be merged to produce a merged solution. The value pattern outcome may be constructed and produced based on the merged solution.

In an embodiment, establishing the first relationship between the value records may include looking up a set of identifiers for the value records with like values. In an embodiment, establishing the second relationship between the subset of the value records may include comparing the subset of the value indices or the respective data values of the subset of the value records to determine value indices or data values that meet an inequality relationship.

In using the value pattern instance(s) of the value pattern to establish relationships between the value records and produce the value pattern outcomes, for each value pattern instance, a first relationship between the value records may be established based on the value pattern instance, and the respective data values of the value records, to produce a subset of the value records with the first relationship. In some embodiments, a value record may generate derivative value records to establish the first relationship based on fuzzy or approximate matching between two values. In this case, the generated value records may act as proxies to the original value record, thereby allowing the original value record to match other values with limited inexact equality. Furthermore, a second relationship between the subset of the value records may be established based on the value pattern instance, and the respective data values of the subset of the value records.

In an embodiment, each value record may include at least one of: a record identifier (ID), a field identifier/name, an ingest timestamp, a metadata version identifier, the data value in the value record, a data type of the data value, or a semantic type of the data value.

In an embodiment, backfilling the metadata edits to the value records comprises locating a value entry in the value records and publishing an updated value entry with the metadata edits.

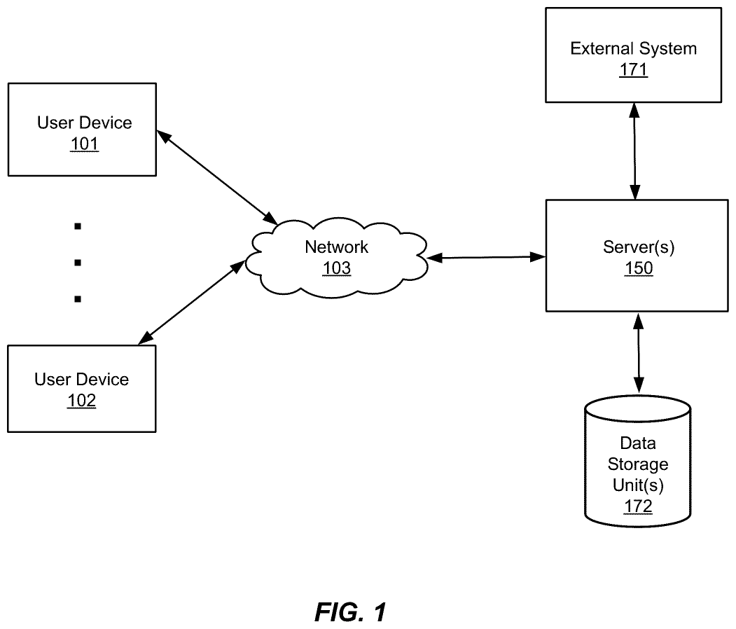

FIG. 1 is a block diagram illustrating a processing system according to an embodiment. Referring to FIG. 1, processing system 100 includes, but is not limited to, one or more user devices 101-102, a network 103, one or more servers 150, and external system 171, and one or more data storage units 172. User devices 101-102 may be communicatively coupled (or synchronously connected or asynchronously connected) to server(s) 150 over network 103. User devices 101-102 may be any type of devices such as a host or server, a personal computer (e.g., desktops, laptops, and tablets), a “thin” client, a personal digital assistant (PDA), a Web enabled appliance, a mobile phone (e.g., Smartphone), a wearable device (e.g., Smartwatch), Internet of Things (IoT) device, etc. In some embodiments, user devices 101-102 may be in control of a user (e.g., employee, staff, member, contractor, etc.) and may be used to perform enterprise functions that require access to organization/company systems.

With continued reference to FIG. 1, network 103 may be any type of networks such as a local area network (LAN), a wide area network (WAN) such as the Internet, a fiber network, a storage network, or a combination thereof, wired or wireless. Server(s) 150 is communicatively coupled or connected to external system 171 and data storage units 172, which may be over a network similar to network 103. Server(s) 150 may be any kind of server or a cluster of servers, such as Web or cloud servers, application servers, backend servers, or a combination thereof.

External system 171 can be any computer system with computational and network-connectivity capabilities to interface with server(s) 150. In an embodiment, external system 171 may include multiple computer systems. That is, external system 171 may be a cluster of machines sharing the computation and source data storage workload. In an embodiment, data storage unit 172 may be any memory storage medium, computer memory, database, or database server suitable to store electronic data. External system 171 may be part of a government, business, or organization performing government functions, business functions, or organizational functions, respectively.

Data storage units 172 may be separate computers independent from server(s) 150. Data storage units 172 may also be relational data storage units. In an embodiment, data storage units 172 may reside on external system 171, or alternatively, can be configured to reside separately on one or more locations. In another embodiment, data storage units 172 may be cloud-based data storage units or mediums.

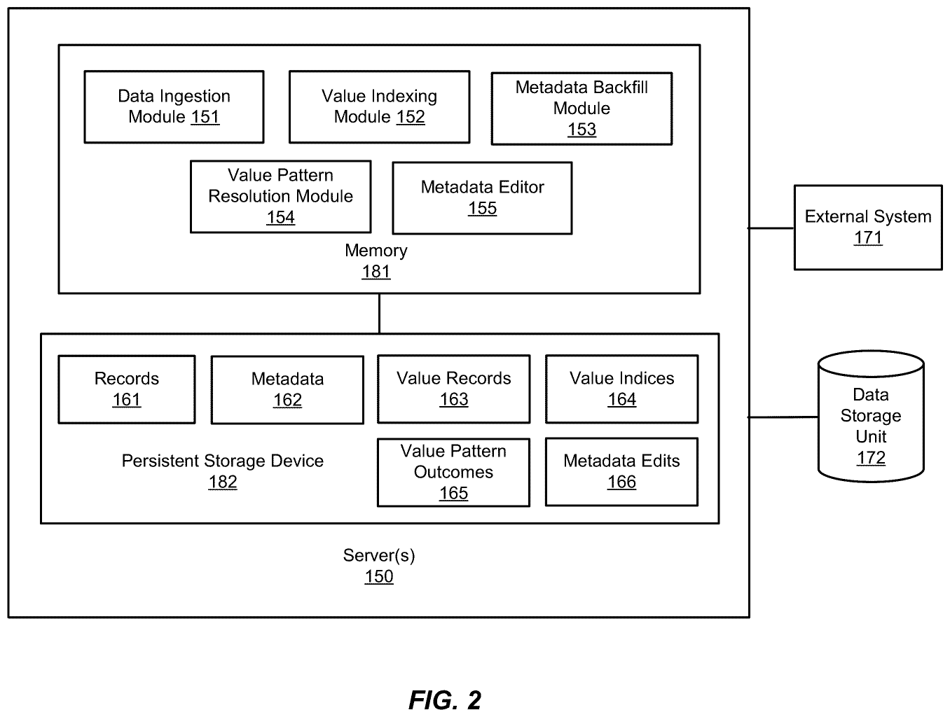

FIG. 2 is a block diagram illustrating a server system according to an embodiment. Referring to FIG. 2, server(s) or server system 150 includes, but not limited to, data ingestion module 151, value indexing module 152, metadata backfill module 153, value pattern resolution module 154, and metadata editor 155. Some or all of modules/nodes/processes 151-155 may be implemented in software, hardware, or a combination thereof. For example, these modules/nodes/processes may be installed on persistent storage device 182 (e.g., hard disk, solid state drive), loaded into memory 181, and executed by one or more processors (not shown) of server(s) 150. Note that some or all of these modules/nodes/processes may be communicatively coupled to or integrated with some or all modules/nodes/processes of server(s) 150. Some of modules/nodes/processes 151-155 may be integrated together as an integrated module/node/process.

In an embodiment, data ingestion module 151 may accept or receive data (e.g., text messages, social media posts, stock market feeds, traffic reports, weather reports, or any other kinds of data) from one or more sources of data (e.g., external system 171, data storage units 172, or other sources) as records, which may be in different formats. For example, the data may be pushed where the data is provided directly to server(s) 150 when available (i.e., direct feed). Alternatively, the source data may be pulled where server(s) 150 (data ingestion module 151) requests the source data periodically from the sources, for example through a database query such as Solr, structured query language (SQL), etc. The data may be ingested concurrently per source. In certain formats (e.g., comma-separated values (CSV), Java Script Notation (JSON), Extensible Markup Language (XML), etc.), field names are present in the records. In other formats, the field names are not embedded in the records, but may be obtained from a schema registry (e.g., Apache Avro™, Protocol Buffers (Protobuf), etc.). Upon receiving or ingesting the source data, module 151 may store the source data as records 161 on persistent storage device 182 or data storage units 172. Records 161 may be in any format, such as CSV, JSON, XML, etc.

Data ingestion module 151 may break each incoming record 161 into separate per-value records 163 for downstream processing, and extract metadata 162 where available which may aid in downstream processing. For example, each value in each record 161 may be output with a record identifier (ID), a field identifier/name if known, an ingest timestamp, the value, a data type of the value, and/or a semantic type of the value. The data type may be the physical type of the value (e.g., string, number, date time, geo point, geo polygon, etc.), and the semantic type is a categorization of a role of the value (e.g., entity identifier, date time, dimension, metric, etc.). Some roles can be determined by automation (e.g., entity identifier for a social security number (SSN), Internet protocol (IP) address, phone number, date time for strings matching date time formats, dimension for state name, country name, etc.). When multiple values have the same content and the same role, they may be expected to have a strong relationship to each other, and their respective records.

In an embodiment, data ingestion module 151 may look for values inside of textual data. This includes, for example looking for embedded SSN, IP, proper names, etc. in text, and extracting that information as separate values associated with a record 161 and field in question. Module 151 may also produce metadata (or metadata summary) 162 of the sources, fields, seen data, and semantic types for each source. This information may be used to assist user interfaces that view the data or that direct data usage and provide a basis for edit operations.

Once value records 163 are produced, which may be in the form of a value stream, value indexing module 152 may index them to produce value indices 164 that allow search operations to be performed and interactive joins/navigation to be performed. For example, given a SSN value “XXX-NN-MMMM”, module 152 may navigate to a set of records associated with that SSN, then navigate to a set of all IP address values for any of those records, and so on. The value indexing may focus on sets of record IDs having the same value in common, having the same value in the same field, having values with a defined relationship for metrics, or having the same or related dimension values. The indexing process may support updates to allow for changes in value metadata and for revision of field values in ingested records with the same primary key or keys (also called upserts). This indexing can be performed using stream processing (e.g., Apache Flink, KStreams, Apache Spark, etc.) or a distributed/persistent data storage capable of accepting streams of data (e.g., Apache Pinot, KSQL, Apache Druid, PostgreSQL, etc.).

In addition to the metadata 162 produced from records 161 (ingested data), in some embodiments, a user, through metadata editor 155, can augment or edit the metadata 162 and generate metadata edits 166 by creating hierarchies of dimension values (e.g., countries, containing states, containing counties, etc.), or hierarchies of terms that have indicative meaning (called lexicons or ontologies), which may be used to extract values from textual data. Metadata edits 166 may include definition of primary key or keys for sources allowing record identifiers to be derived from the source data which allows for updates to be applied to earlier copies of the record, for example value records or value stream 163. This sometimes is called change data capture.

Thus, given a set of sources being ingested and their metadata, and/or manually created metadata (e.g., prior to or after ingesting the data), the user may have the option to edit the metadata 162 the system is using. When such edit occurs and is finalized by the user, metadata backfill module 153 may backfill those changes to the value stream (value records 163) using updates. For each value targeted by the edit, module 153 may locate that value entry and publish an updated value entry with the revised metadata. This may involve modifying the semantic type for a field, or creating a new pattern for a semantic type locator or modifying entries to the dimension or term hierarchies. In the case of term hierarchies or semantic type locators, the backfill may involve reading all the values of type text and looking for additional values in the text. In the case of dimensional hierarchy changes, in the ideal case the values may not be impacted only possibly the indexing of those values into the dimensional hierarchy.

In an embodiment, value pattern resolution module 154 may use value records 163 (or value stream) to detect sets of records that comply with a value pattern and publish matching records in value pattern outcomes 165. An example value pattern may be two people being asserted to be the same person if their records are connected by the same first name, last name, and either their SSN or three addresses in common (e.g., used by FICO to establish entity equivalence). Value patterns are not always the linkage between two individual records but can be multiple constellations of related records. For example, the addresses from above could be in separate records from the entity records if there is a clear association between the records in that constellation.

In an embodiment, value pattern resolution module 154 may use value patterns to establish relationships between value records 163 based on values within those records. In the case of values with a certain semantic type, for example entity ID, the assertion is that any records with the same value are related to the same entity regardless of the field in which they occur. But in some cases, the type of relationship can be established with a more careful definition. For example, in a law enforcement context, the connection between a criminal investigation and people that are suspects is different from that for witnesses. In this case, a pattern can be introduced into the metadata that impacts the indexing of the records and their use in downstream systems. In this case, the field name containing the value may have the key differentiator, or it may be needed to look for terms in proximity to the value extracted from a report to understand the context of the value, in some cases the input data is formatted as the context for a large language model (LLM) and the role of the data extracted by submitting a prompt to the contextualized model.

Note that while records 161, metadata 162, value records 163, value indices 164, value pattern outcomes 165 and metadata edits 166 are shown to be stored on persistent storage device 182, in some embodiments, those information may be stored on a distributed/persistent data storage that can accept streams of data (e.g., Apache Pinot, KSQL, Apache Druid, PostgreSQL, etc.).

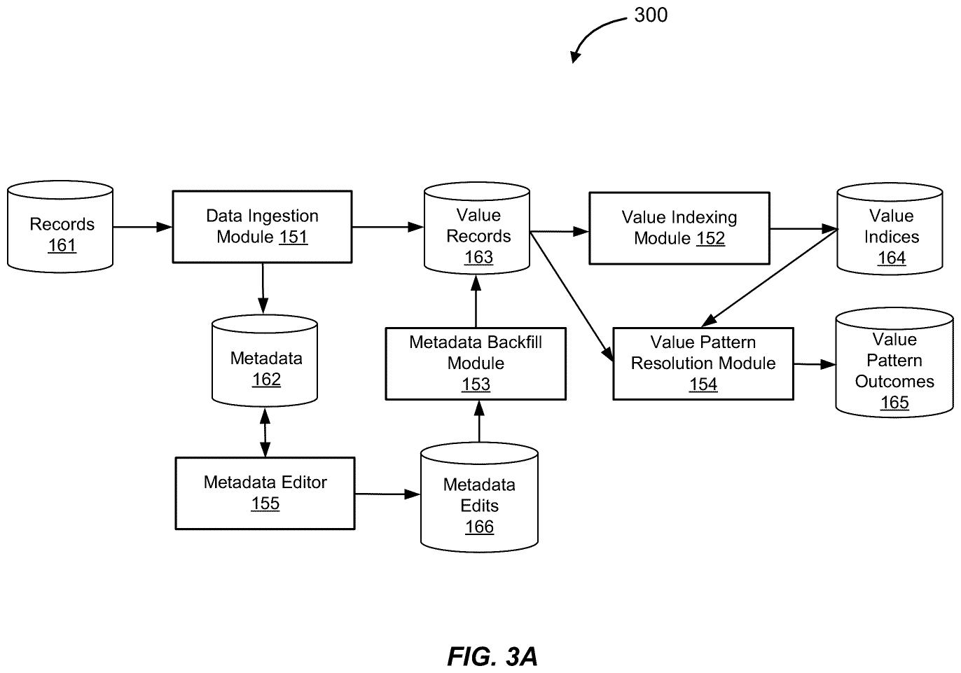

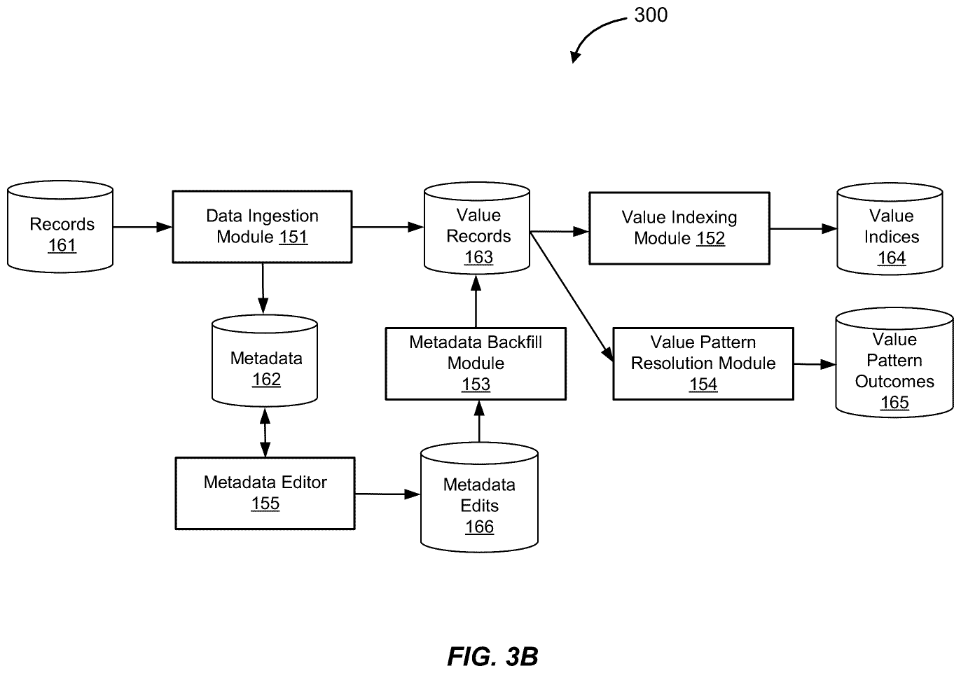

FIGS. 3A-3B are block diagrams illustrating a value analysis data flow according to embodiments of the disclosure. In FIGS. 3A-3B, data flow 300 may begin with source (or raw) data being provided to data ingestion module 151 as records 161. Records 161 may be in various formats, for example JSON, XML, Protobuf, CSV, etc. In an embodiment, module 151 may access records 161 using a transport method, such as reading records 161 from a database, streaming records 161 over a distributed data streaming platform (e.g., Apache Kafka, Apache Pulsar, etc.), reading records 161 from a change data capture stream, or pushing records 161 to module 151 using, for example, a web service or socket type transport.

Regardless of the transport method, module 151 may process records 161 one record at a time, even if the records 161 are received in batches. For each source of data over each transport, a separate instance of data ingestion module 151 (ingest process) may be initiated to receive records 161 and process them. After processing records 161, two types of outputs are generated. The first type of output is metadata about the records 161 (metadata 162), and the second type of output is value records 163, which may be restructured value records in some embodiments. In an embodiment, metadata 162 may include a set of physical data types and semantic types found in each field of the incoming records 161. Data type may be the physical type of a value (e.g., string, number, date time, geo point, geo polygon, etc.), and the semantic type may be a categorization of a role of the value (e.g., entity identifier, date time, dimension, metric, etc.). In some embodiments, if records 161 have multiple schemas, the field names are not differentiated into separate subschemas. The analysis of metadata 162 may also reflect which field, if any, is the primary key of a record. This can be determined in several ways based on which apply: 1) a universally unique identifier (UUID) value in a field assumed to be the primary key (id, <source name>_id, or the like by heuristic method), 2) a numeric value increasing monotonically with gaps allowed, etc.

The value records 163 may include one value per record, a field name, a physical data type, a semantic type, and in the case of term or dimension hierarchies, the element in the hierarchy that matches the value. In the case of text or string fields, data ingestion module 151 may extract values from within the text that match various term hierarchy matches, or substrings that match defined matching definitions (e.g., SSN, IP address, phone number, addresses, etc.). In an embodiment, the value matching within the string is using regular expressions, using LR grammars or the like, using Finite State Transformers, using machine learning language models, or using large language models.

In an embodiment, value indexing module 152 receives the value records 163 and indices them by value, field, and/or semantic type to produce value indices 164. Indices 164 may include inverted indices, B-Trees, etc. For each entry in the indices 164, record identities that have that value or in the case of hierarchies matches one of the subordinate nodes in the hierarchy may be tracked. For example, if a term hierarchy was built for names of animal species grouped into the typical groupings, a record that matched the term for “Monkey” may also be indexed for “Mammal” and “Vertebrate”, etc. In cases like IP addresses, indexing can be by ranges of values rather than for only specific values, as directed by the user or the use of value patterns that reflect range comparisons. The output of module 152 is the value indices 164 that allow outside users (e.g., front end software, external API access, or internal uses such as value patterns) to perform set operations on the records containing specific values or ranges of values.

In an embodiment, metadata editor 155 may be a user interface component or application that allows a user to adjust the metadata 162 detected by the automated system for records. This includes specifying for specific sources and transports the primary key (composite of multiple fields or specific field), to define an expected physical type for fields (e.g., number as primary key rather than as metric, string as datetime rather than generic string, string containing potential hierarchy references or not containing them, etc.). This allows the user with knowledge of the format of the data to refine or optimize the processing of that source of data and/or that transport. In the case where the ingest automation (data ingestion module 151) detected something in conflict with what the user is indicating the user has the option to treat the data as primary, the user as primary, or to reject incoming records that do not comply with the user defined aspect. In this rejection case, data ingestion module 151 may place rejected records aside for review and further processing. The output of the use of editor 155 is a set of metadata edits 166 (changes to be used in processing the incoming data). These metadata edits 166 can be reviewed by the user and their impact on a sample of records reviewed before placing the changes into operation. Once put into operation by metadata backfill module 153, metadata edits 166 may have two effects. First, backfill module 153 may use metadata edits 166 to update the metadata used for reference by data ingestion module 151, and they may produce a set of operations to be applied to data previously ingested to adjust for the changes. This can mean issuing updates to value records 163 with the changes to be substituted for the prior records, or it can mean a direct update to the proper indices by value indexing module 152 (indexing process). For example, if a record is ingested with a field “witness_id” which was interpreted by the automated system (data ingestion module 151) as a string, and the user (through metadata editor 155) changes it to “Entity ID” semantic type, the edit changes may produce new/updated value records 163 for each of the records 161 for that field updating the semantic type from “String” to “Entity ID”, or it can query the index for all records with the field “witness_id” and delete them from the “String” index and add them to the “Entity ID” index. Therefore, the value indices for the actual record values would not need to change as this is only affecting the metadata of the record. The reason one method may be used over the other (or both used) depends on whether the value records 163 are to be used directly by another process, or only the value indices 164 will be used. If the value records 163 are only needed for indices production, then directly updating the index is more efficient and performant. If the value records 163 are used by another process, such as value pattern resolution module 154 or outside streaming, then updating the value records 163 should be produced to update those consumers of the change. Both are appropriate if updating the value indices 164 directly is faster and latency is a concern for update, and the value records 163 produced would add higher latency than direct index updates. In some embodiments, directly updating the indices 164 may not be any faster, in which case only the value records 163 need be updated.

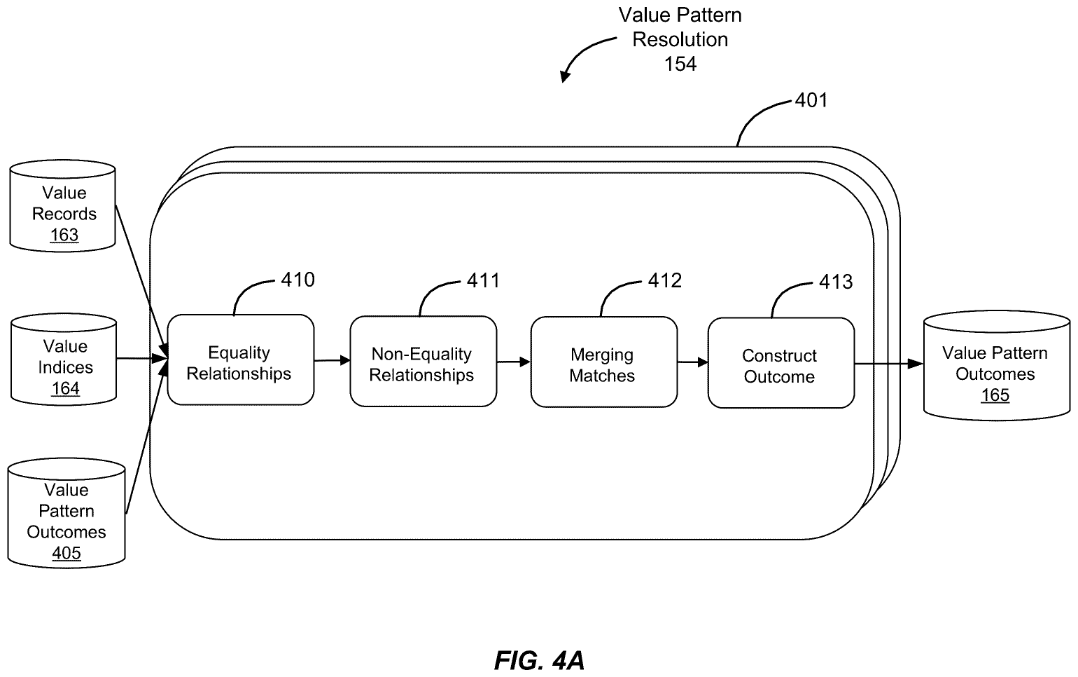

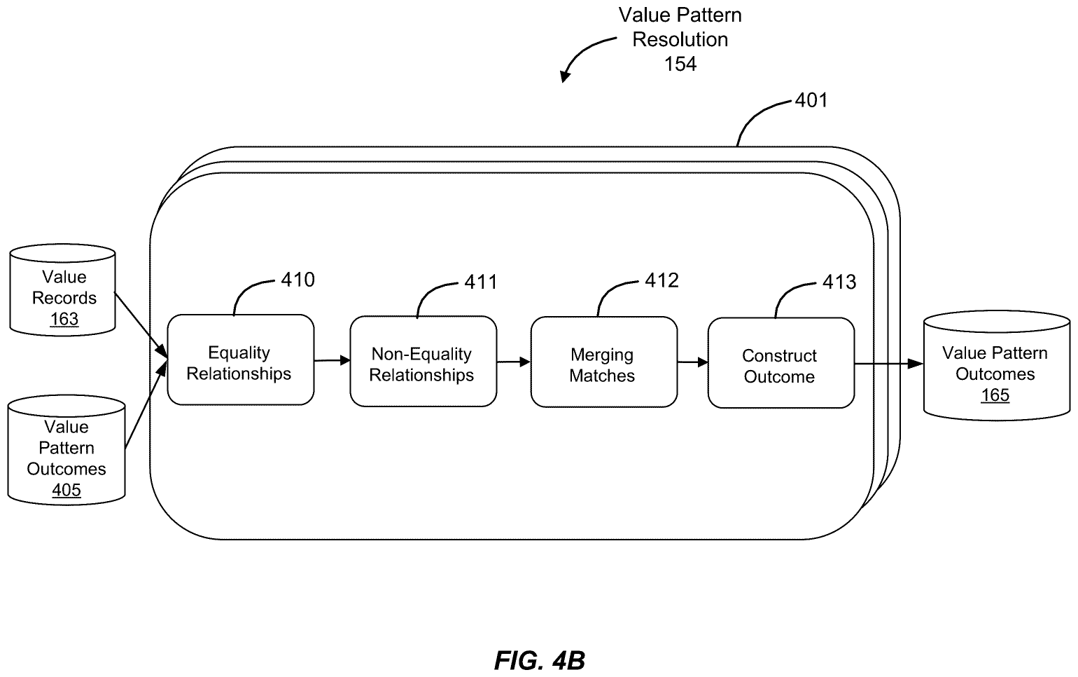

Referring now to FIGS. 3A-3B and 4A-4B, value pattern resolution module 154 may receive value records 163. The receipt of the value records may trigger changes in the state of the value patterns. Each value pattern may be user created or created through automation. Each value pattern can have multiple pattern instances 401, one per combination of partition keys (values of significance to the pattern). Each pattern instance 401 of a value pattern may collect a set of incoming values that matches the value pattern. The values can come from any data source or be limited to specific data sources or specific fields. The relationship between the values may be specified in the value pattern.

In an embodiment, for streaming only pattern evaluation, there can be an equality relationship between each element of the pattern (value place holder), and other relationships may also be specified. For streaming and indices, the outcome of the pattern may be updated upon receipt of a new value or upon a periodic re-evaluation of the pattern, though the outcome can have a more flexible set of relationships between elements.

In an embodiment, upon receiving value records 163, pattern instances 401 are checked by value pattern resolution module 154 for impact against input current value indices 164 and updated value pattern outcomes 405 produced if appropriate (see FIGS. 3A and 4A). In another embodiment, the value records 163 may be used in each pattern instance 401 and recorded locally (with value records 163 and value pattern outcomes 405 as inputs, as shown in FIGS. 3B and 4B). In this streaming only embodiment, each pattern instance 401 may operate independently without the need to access the indices 164. This latter embodiment increases local storage needs, though increases concurrency and reduces load on the indices 164 in cases that are of higher importance than pattern processing.

Referring now to FIG. 4A, each pattern instance 401 is based on building sets of value records that have the desired relationships. Each pattern instance 401 may include elements (or slots that can hold a set of value records), and constraints (relationships) between those sets. In some embodiments, the primary relationships are equality relationships, meaning that two elements may have a value in common. At block 410, equality relationships may be processed using value indices 164. This process may include looking up a set of unique IDs for value records 163 with like values, for streaming the set of record unique IDs is constructed by observing value records 163 with the same value. At block 411, non-equality relationships are processed. This process includes comparing the value indices or aggregated value records for subsets of the equality relationships that also meet the inequality relationships. This means obtaining relevant values for each value record in an equality relationship for a desired inequality relationship, either from indices or from captured value records. An example of non-equality relationship processing can be two value records that emit a value record having the same value in the “name” field and value records for “age” that are not equal. For example, a value pattern that is looking for “name” and “age” being equal may yield no record that satisfies the pattern. On the other hand, if the value pattern was looking for equal “name” and inequal “age”, it would result in a solution with one record in one element and one record in the other element.

In some embodiments, solutions can be routed through each relationship (equality or inequality) either in pairs and merged (block 412) after all relationships have applied their filtering, or full sets can be routed through relationships resulting in a finished solution without need for merging. In the case of value indices, set representation can reference index nodes, while in value streaming only a compressed enumeration of keys is passed through or referenced by the relationship processing. In cases where an equality is fuzzy (e.g., +/− a value, or with an offset) a synthetic value may be injected into the data flow from the value record to bracket or bucket the possible values and a simple equality can be used in the remainder of the flow, with solutions merged after all relationships have been processed (block 412). For example, if value 2 is received with +/−3 match, values for −1, 0, 1, 2, 3, 4, 5 are all passed into the relationship processing, and matching results merged based on the original input value.

Once a solution exists for a pattern instance 401 (e.g., set of record IDs for each element), a value pattern outcome 165 is constructed and produced (at block 413). In an embodiment, value pattern outcome 165 may change over time as new data (e.g., incoming records 161 of FIGS. 3A-3B) is received. The output 165 of each value pattern may be a stream of instances or instance updates that can be received by other systems/processes or fed back into data ingestion module 151 to produce the updated value pattern outcomes 405, which may be analyzed in a different context against possibly different patterns. The outcome 405 may include a pattern identifier, an instance partition key value, and/or a record ID that matches each element in the solution for that particular pattern instance 401. This outcome can be input into other processes that are looking for pattern matches to trigger other processes or to combine pattern matches with other data.

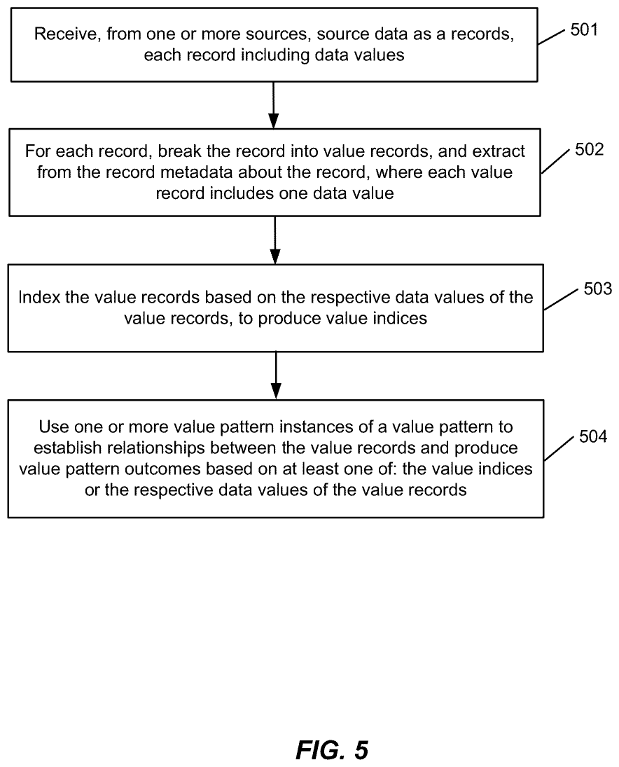

FIG. 5 is a flow diagram illustrating a process of analyzing data values according to an embodiment. Process 500 may be performed by processing logic which may include software, hardware, or a combination thereof. For example, process 500 may be performed by server(s) 150, e.g., any combination of processes 151-155 of FIG. 2.

Referring to FIG. 5, at block 501, the processing logic receives, from one or more sources, source data as a records. Each record includes data values. At block 502, for each record, the processing logic breaks the record into value records, and extract from the record metadata about the record, where each value record includes one data value. At block 503, the processing logic Indexes the value records based on the respective data values of the value records, to produce value indices. At block 504, the processing logic uses one or more value pattern instances of a value pattern to establish relationships between the value records and produce value pattern outcomes based on at least one of: the value indices or the respective data values of the value records.

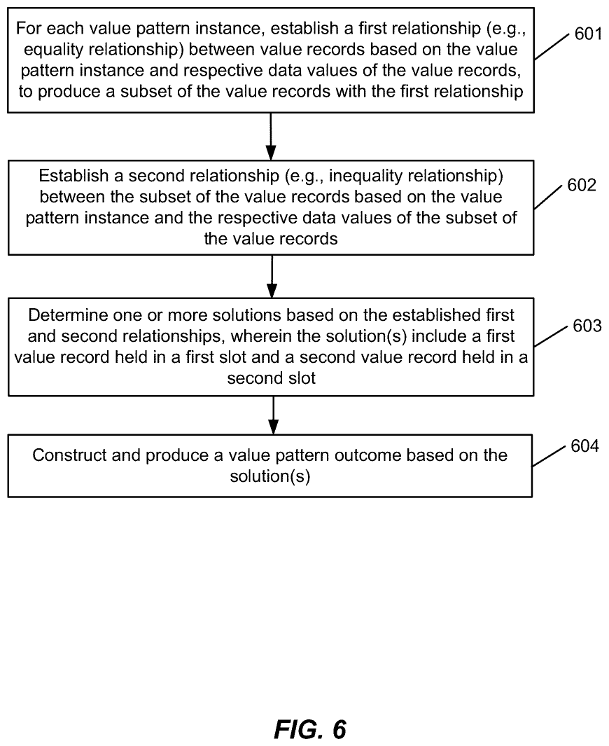

FIG. 6 is a flow diagram illustrating a process for value pattern resolution according to an embodiment. Process 600 may be performed by processing logic which may include software, hardware, or a combination thereof. For example, process 600 may be performed by server(s) 150, e.g., process 154 of FIG. 2.

Referring to FIG. 6, at block 601, For each value pattern instance, the processing logic establishes a first relationship (e.g., equality relationship) between value records based on the value pattern instance and respective data values of the value records, to produce a subset of the value records with the first relationship. At block 602, the processing logic establishes a second relationship (e.g., inequality relationship) between the subset of the value records based on the value pattern instance and the respective data values of the subset of the value records. At block 603, the processing logic determines one or more solutions based on the established first and second relationships, wherein the solution(s) include a first value record held in a first slot and a second value record held in a second slot. At block 604, the processing logic constructs and produces a value pattern outcome based on the solution(s).

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method of analyzing data values, the method comprising:
receiving, from one or more sources, source data as a plurality of records, each record comprising a plurality of data values;
for each record, breaking the record into a plurality of value records, and extracting from the record metadata about the record, wherein each value record comprises one data value;
indexing the plurality of value records based on the respective data values of the plurality of value records, to produce a plurality of value indices; and
using one or more value pattern instances of a value pattern to establish relationships between the plurality of value records and produce value pattern outcomes based on at least one of: the plurality of value indices or the respective data values of the plurality of value records.

2. The method of claim 1, further comprising:
backfilling metadata edits to the plurality of value records, wherein the metadata edits are edits made to the extracted metadata about the plurality of records.

3. The method of claim 1, wherein using the one or more value pattern instances of the value pattern to establish relationships between the plurality of value records and produce the value pattern outcomes comprises:
for each value pattern instance,
establishing a first relationship between the plurality of value records based on the value pattern instance, the plurality of value indices, and the respective data values of the plurality of value records, to produce a subset of the plurality of value records with the first relationship and a subset of the plurality of value indices corresponding to the subset of the plurality of value records, and
establishing a second relationship between the subset of the plurality of value records based on the value pattern instance, the subset of the plurality of value indices, and the respective data values of the subset of the plurality of value records.

4. The method of claim 3, wherein
each value pattern instance includes a plurality of slots holding a set of value records;
using the one or more value pattern instances of the value pattern to establish relationships between the plurality of value records and produce the value pattern outcomes further comprises:
for each value pattern instance,
determining one or more solutions based on the established first and second relationships, wherein the one or more solutions include a first value record held in a first slot and a second value record held in a second slot, and
constructing and producing a value pattern outcome based on the one or more solutions.

5. The method of claim 4, wherein
using the one or more value pattern instances of the value pattern to establish relationships between the plurality of value records and produce the value pattern outcomes further comprises: for each value pattern instance, merging the one or more solutions to produce a merged solution;
constructing and producing the value pattern outcome comprises constructing and producing the value pattern outcome based on the merged solution.

6. The method of claim 3, wherein establishing the first relationship between the plurality of value records comprises looking up a set of identifiers for the plurality of value records with like values.

7. The method of claim 3, wherein establishing the second relationship between the subset of the plurality of value records comprises comparing the subset of the plurality of value indices or the respective data values of the subset of the plurality of value records to determine value indices or data values that meet an inequality relationship.

8. The method of claim 1, wherein using the one or more value pattern instances of the value pattern to establish relationships between the plurality of value records and produce the value pattern outcomes comprises:
for each value pattern instance,
establishing a first relationship between the plurality of value records based on the value pattern instance and the respective data values of the plurality of value records, to produce a subset of the plurality of value records with the first relationship, and
establishing a second relationship between the subset of the plurality of value records based on the value pattern instance and the respective data values of the subset of the plurality of value records.

9. The method of claim 1, wherein each value record comprises at least one of: a record identifier (ID), a field identifier/name, an ingest timestamp, a metadata version identifier, the data value in the value record, a data type of the data value, or a semantic type of the data value.

10. The method of claim 2, wherein backfilling the metadata edits to the plurality of value records comprises locating a value entry in the plurality of value records and publishing an updated value entry with the metadata edits.

11. A server system, comprising:
one or more processors; and
one or more memories coupled to the one or more processors to store instructions, which when executed by the one or more processors, cause the one or more processors to perform operations, the operations comprising:
receiving, from one or more sources, source data as a plurality of records, each record comprising a plurality of data values;
for each record, breaking the record into a plurality of value records, and extracting from the record metadata about the record, wherein each value record comprises one data value;
indexing the plurality of value records based on the respective data values of the plurality of value records, to produce a plurality of value indices; and
using one or more value pattern instances of a value pattern to establish relationships between the plurality of value records and produce value pattern outcomes based on at least one of: the plurality of value indices or the respective data values of the plurality of value records.

12. The server system of claim 11, wherein the operations further comprise:
backfilling metadata edits to the plurality of value records, wherein the metadata edits are edits made to the extracted metadata about the plurality of records.

13. The server system of claim 11, wherein using the one or more value pattern instances of the value pattern to establish relationships between the plurality of value records and produce the value pattern outcomes comprises:
for each value pattern instance,
establishing a first relationship between the plurality of value records based on the value pattern instance, the plurality of value indices, and the respective data values of the plurality of value records, to produce a subset of the plurality of value records with the first relationship and a subset of the plurality of value indices corresponding to the subset of the plurality of value records, and
establishing a second relationship between the subset of the plurality of value records based on the value pattern instance, the subset of the plurality of value indices, and the respective data values of the subset of the plurality of value records.

14. The server system of claim 13, wherein
each value pattern instance includes a plurality of slots holding a set of value records;
using the one or more value pattern instances of the value pattern to establish relationships between the plurality of value records and produce the value pattern outcomes further comprises:
for each value pattern instance,
determining one or more solutions based on the established first and second relationships, wherein the one or more solutions include a first value record held in a first slot and a second value record held in a second slot, and
constructing and producing a value pattern outcome based on the one or more solutions.

15. The server system of claim 14, wherein
using the one or more value pattern instances of the value pattern to establish relationships between the plurality of value records and produce the value pattern outcomes further comprises: for each value pattern instance, merging the one or more solutions to produce a merged solution;
constructing and producing the value pattern outcome comprises constructing and producing the value pattern outcome based on the merged solution.

16. The server system of claim 13, wherein establishing the first relationship between the plurality of value records comprises looking up a set of identifiers for the plurality of value records with like values.

17. The server system of claim 13, wherein establishing the second relationship between the subset of the plurality of value records comprises comparing the subset of the plurality of value indices or the respective data values of the subset of the plurality of value records to determine value indices or data values that meet an inequality relationship.

18. The server system of claim 11, wherein using the one or more value pattern instances of the value pattern to establish relationships between the plurality of value records and produce the value pattern outcomes comprises:
for each value pattern instance,
establishing a first relationship between the plurality of value records based on the value pattern instance and the respective data values of the plurality of value records, to produce a subset of the plurality of value records with the first relationship, and
establishing a second relationship between the subset of the plurality of value records based on the value pattern instance and the respective data values of the subset of the plurality of value records.

19. The server system of claim 11, wherein each value record comprises at least one of: a record identifier (ID), a field identifier/name, an ingest timestamp, a metadata version identifier, the data value in the value record, a data type of the data value, or a semantic type of the data value.

20. The server system of claim 12, wherein backfilling the metadata edits to the plurality of value records comprises locating a value entry in the plurality of value records and publishing an updated value entry with the metadata edits.
